(19) United States
(12) Patent Application Publication
(10) Pub. No.: US 2026/0138142 A1
(43) Pub. Date: May 21, 2026

(54) SYSTEM FOR SPRAYING CLEANING FLUID WITH TWO SPRAY NOZZLES AND A DIRECTIONAL VALVE

(71) Applicant: VALEO SYSTEMES D'ESSUYAGE, La Verriere (FR)

(72) Inventors: Nicolas HORNYCH, La Verriere (FR); Denis THEBAULT, La Verriere (FR)

(73) Assignee: VALEO SYSTEMES D'ESSUYAGE, La Verriere (FR)

(21) Appl. No.: 19/118,405

(22) PCT Filed: Oct. 5, 2023
(86) PCT No.: PCT/EP2023/077655

§ 371 Date: Apr. 4, 2025

(30) Foreign Application Priority Data
Oct. 5, 2022 (FR) FR2210214

(51) Int. Cl. B05B 1/16; B05B 1/20; B05B 1/30; B05B 12/04; B05B 12/08; B60S 1/48; B60S 1/56

(52) U.S. Cl. CPC B05B 1/1663; B05B 1/205; B05B 1/3006; B05B 12/04; B05B 12/087; B60S 1/48; B60S 1/56

(57) ABSTRACT

The present invention relates to a system for spraying cleaning fluid. The system includes a first spray nozzle and a second spray nozzle, each capable of receiving cleaning fluid and spraying it. The system also includes a directional valve with an inlet, a first outlet and a second outlet. The directional valve being capable of conveying cleaning fluid from the inlet to the first outlet when cleaning fluid received at the inlet has a pressure below a given threshold, and which is capable of conveying cleaning fluid from the inlet to the second outlet when the cleaning fluid received at the inlet has a pressure above the given threshold. The system further includes a pump capable of injecting fluid into the directional valve and capable of varying the pressure of the fluid.

### TECHNICAL FIELD

The present invention relates to a cleaning fluid spraying system, notably for motor vehicle wiping systems, and in particular to a spraying system comprising at least two different spray nozzles.

### BACKGROUND OF THE INVENTION

Equipment such as a motor vehicle frequently has a cleaning fluid spraying system with several spray nozzles, sometimes even of different types, to perform various functions, notably for cleaning sensor surfaces or windows. Such a multi-nozzle spraying system is not specific to motor vehicles and may be useful for other equipment comprising several surfaces to be cleaned.

It may be envisaged to share a pump for feeding cleaning fluid to the nozzles of a spraying system. In order to selectively feed two spray nozzles, notably to feed one and then the other, it is known practice to use a solenoid valve between each spray nozzle and the pump. The solenoid valve can be controlled by an electrical signal so as to distribute or not the cleaning fluid to the spray nozzle.

However, control by electrical signal is not very robust, notably in the event of electrical failure or mechanical shock, involves the use of space-intensive electrical wires, and is expensive.

There is thus a need to propose a cleaning fluid spraying system with at least two spray nozzles and a single pump, which is robust, space-saving, lightweight and also inexpensive.

### SUMMARY OF THE INVENTION

The present invention improves the situation.

A first aspect of the invention relates to a system for spraying cleaning fluid, comprising:
a first spray nozzle and a second spray nozzle, each capable of receiving cleaning fluid and of spraying said cleaning fluid out of the spraying system, for example onto the protective surface of a sensor;
a directional valve comprising an inlet, a first outlet and a second outlet, the directional valve being capable of directing cleaning fluid from the inlet to the first outlet when cleaning fluid received at the inlet has a pressure below a given threshold, and capable of directing cleaning fluid from the inlet to the second outlet when cleaning fluid received at the inlet has a pressure above the given threshold.

This makes it possible to selectively inject cleaning fluid into two spray nozzles, using a single pump, without the need for solenoid valves controlled by electrical wires.

Specifically, the directional valve is capable of being controlled passively, by varying the pressure of the cleaning fluid, either above the given threshold, or below the given threshold. The given threshold may be achieved by a simple mechanical system. Such a mechanical system is more robust than electrical wire control, less space-intensive, less expensive and lighter.

The protective surface of a sensor is the optical surface of the sensor, i.e. the surface through which the sensor's signals are transmitted and/or received. The sensor's protective surface may thus be the sensor lens, the surface of a casing in which the sensor is located, or any other surface protecting the sensor. The protective surface of a sensor is transparent to the signals intended to be transmitted and/or received by the sensor.

For example, the spraying system comprises a pump that is capable of injecting cleaning fluid into the directional valve and capable of varying the pressure of the injected cleaning fluid so that the valve dispenses cleaning fluid into the first spray nozzle or into the second spray nozzle.

According to certain embodiments, the first and second spray nozzles are configured to spray the cleaning fluid onto an optical surface of a motor vehicle sensor.

According to certain embodiments, the first spray nozzle may have at least a first optimum operating value and the second spray nozzle may have at least a second optimum operating value, different from the first optimum operating value; the first optimum operating value of the first spray nozzle may be associated with a first cleaning fluid inlet pressure below the given threshold, and the second optimum operating value of the second spray nozzle may be associated with a second cleaning fluid inlet pressure above the given threshold.

The abovementioned advantages may thus be achieved while at the same time optimally feeding the spray nozzles. The operation of the cleaning fluid spraying system is thus optimized.

In addition, said at least one first optimum operating value may be a flow rate value of the first spray nozzle and/or an inlet pressure value of the first spray nozzle, and said at least one second optimum operating value may be a flow rate value of the second spray nozzle and/or a pressure value of the second spray nozzle.

Thus, the spraying of cleaning fluid for each of the spray nozzles is optimally performed.

According to certain embodiments, the first spray nozzle may be of a first type, the first type defining a first relationship between spray nozzle flow rate value and spray nozzle inlet pressure value, and the second nozzle may be of a second type, the second type defining a second relationship between spray nozzle flow rate value and spray nozzle inlet pressure value.

The same pump can thus be shared between several types of spray nozzles, which may perform different spraying functions or be responsible for cleaning different glazed surfaces.

According to certain embodiments, the first spray nozzle may be of a first type and the second spray nozzle may be of a second type.

For example, the first and second types may be chosen from:
a fixed single spray nozzle;
a fixed double spray nozzle;
a single telescopic spray nozzle;
a telescopic spraying boom with several spray nozzles; and
a fixed spraying boom in the form of a circular arc, for example circular or semicircular, comprising several spray nozzles.

This makes it possible to use a directional valve in a variety of spraying systems, performing different cleaning fluid spraying functions.

In a first embodiment, the first spray nozzle may be a single telescopic spray nozzle, and the second spray nozzle may be a fixed spraying boom in the form of a circular arc, for example circular or semicircular, comprising several spray nozzles.

Thus, two different spraying functions can be performed using a single pump, in a robust, lightweight, inexpensive and space-saving manner.

In a second embodiment, the first nozzle may be a single telescopic spray nozzle, and the second spray nozzle may be a telescopic boom with several nozzles.

Such a spraying system is particularly advantageous in motor vehicles having several different sensors to be cleaned. For example, in an advantageous manner, the single telescopic spray nozzle may be dedicated to the cleaning of a vehicle camera, while the telescopic boom may be dedicated to the cleaning of a vehicle lidar.

According to certain embodiments, the directional valve may comprise a piston in contact with a spring, the piston being capable of sliding in the directional valve to adopt an equilibrium position as a function of a position of the spring and the pressure of the cleaning fluid at the inlet to the directional valve, and the position of the spring may be adjustable by means of an adjusting element so as to modify the given threshold.

Thus, it is possible to modify the given threshold, notably when one of the spray nozzles is replaced with a new spray nozzle. Furthermore, it becomes possible to use a standard directional valve, which is suitable for any spraying system according to the invention. The spraying system is thus less expensive.

In addition, the adjusting element may be a screw, said screw being capable of moving the position of the spring when a rotation is applied to the screw so as to modify the given threshold.

This makes it easy to modify the given threshold.

According to certain embodiments, the directional valve comprises
a first connecting channel through which the fluid can flow, connected to the inlet and to the first outlet,
a first valve head provided with a first loading means, which is movable inside the first connecting channel between an open position when the fluid has a pressure below the given threshold and a closed position when the fluid has a pressure above the given threshold,
a second connecting channel through which fluid can flow, connected to the inlet and to the second outlet,
a second valve head provided with a second loading means, which is movable inside the second connecting channel between an open position when the fluid has a pressure above the given threshold and a closed position when the fluid has a pressure below the given threshold,
   the first connecting channel being configured to be closed when the first valve head moves from its open position to its closed position, the second connecting channel being configured to be closed when the second valve head moves from its open position to its closed position.

For example, the first and second valve heads are balls.

For example, the first and second loading elements are return elements, for example springs.

For example, the first connecting channel comprises a constriction downstream of the first valve head.

For example, the second connecting channel comprises a constriction upstream of the second valve head.

The present disclosure also relates to an assembly comprising the spraying system according to one of the abovementioned features and at least a first sensor protective surface and a second sensor protective surface, the first nozzle being configured to spray fluid onto the first protective surface and the second nozzle being configured to spray fluid onto the second protective surface.

According to certain embodiments, the assembly also comprises a first sensor configured to emit and/or receive signals through the first protective surface, and a second sensor configured to emit and/or receive signals through the second protective surface.

### BRIEF DESCRIPTION OF DRAWINGS

Other features and advantages of the invention will also emerge firstly from the following description, and secondly from several illustrative and nonlimiting examples given as a guide with reference to the appended schematic drawings, in which:

FIG. 1 illustrates a system for spraying cleaning fluid according to certain embodiments of the invention.

FIG. 2 illustrates the structure of a directional valve according to one of the embodiments of the invention.

FIG. 3 illustrates another embodiment of a directional valve.

FIG. 4a, FIG. 4b, FIG. 4c and FIG. 4d represent different types of spray nozzle.

### DETAILED DESCRIPTION OF THE INVENTION

It should first be noted that, while the figures provide a detailed description of the invention as implemented, they may of course be used to better define the invention where appropriate. It should also be noted that, throughout the figures, elements that are similar and/or that fulfil the same function are indicated by the same numbering.

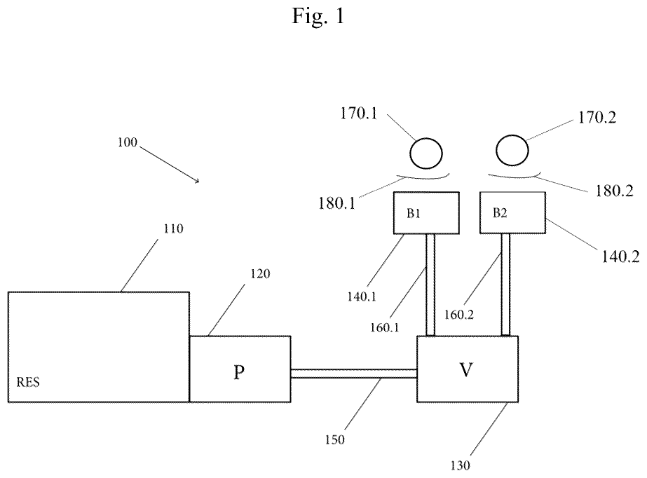

FIG. 1 illustrates a system 100 for spraying cleaning fluid according to certain embodiments of the invention.

Such a cleaning fluid spraying system may be installed on a motor vehicle, or on any other apparatus or vehicle comprising surfaces to be cleaned, notably glazed surfaces, requiring regular or usual cleaning. For example, the surfaces to be cleaned are protective surfaces 180.1, 180.2, of sensors 170.1, 170.2. In the text hereinbelow, the example of a motor vehicle cleaning fluid spraying system 100 is considered for illustrative purposes.

The system 100 comprises a cleaning fluid tank 110 storing cleaning fluid, and on which is arranged a pump 120, comprising a pump motor not shown in FIG. 1.

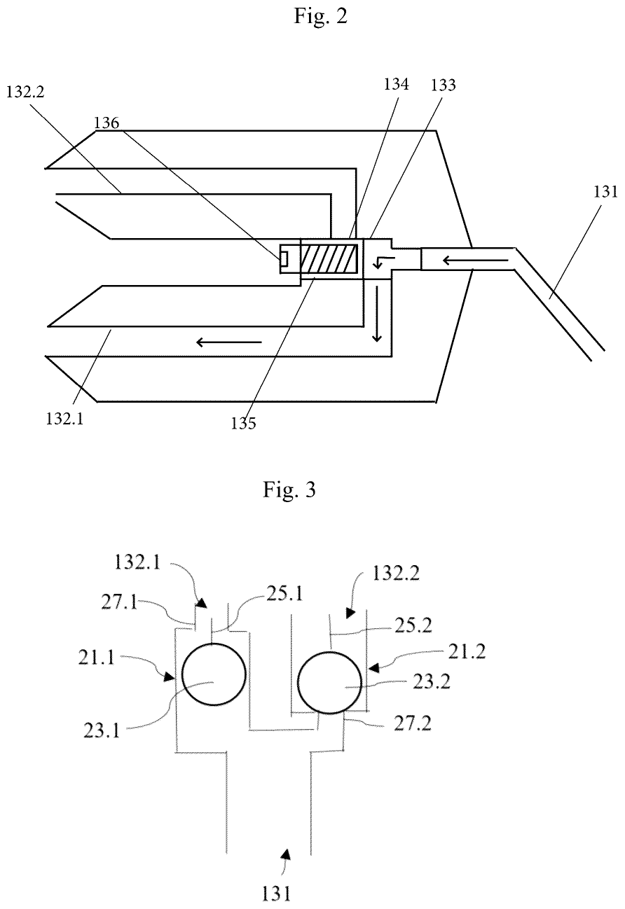

When its motor is active, pump 120 is capable of pumping cleaning fluid from tank 110 so as to inject it into an injection channel 150. The injection channel 150 thus connects the outlet of pump 120 to an inlet of a directional valve, the structure of which will be better understood on reading the description of FIG. 2. According to the invention, pump 120 comprises a variable-speed motor, said speed being expressed in revolutions per minute, which may take values of about a few thousand revolutions per minute.

No restrictions are placed on the injection channel, which may be rigid or flexible, with a length depending on the respective locations of pump 120, tank 110 and directional valve 130. For example, the length of the injection channel may be between 1 and 10 meters, for example equal to 5 meters.

The directional valve 130 comprises a first outlet connected to a first spray nozzle 140.1 via a first distribution channel 160.1 and a second outlet connected to a second spray nozzle 140.2 via a second distribution channel 160.2. The directional valve 130 is capable of directing cleaning fluid from the inlet of valve 130 to the first outlet when the cleaning fluid is received at the inlet at a pressure below a given threshold. The directional valve 130 is also capable of directing cleaning fluid from the inlet of valve 130 to the second outlet when the cleaning fluid is received at the inlet at a pressure above the given threshold.

The directional valve 130 may thus be controlled passively, and mechanically, in such a manner as to select the outlet to which the cleaning fluid is directed. Compared with dedicated solenoid valves in the prior art solution, the use of a directional valve affords improved reliability of the valve control, since it is then independent of an external control circuit, and thus avoids the use of electrical control wires and reduces the size, weight and costs associated with the cleaning fluid spraying system.

No restrictions are placed on the given threshold, which may have an ad hoc value, or which may be a range of fluid inlet pressure values in the directional valve 130. When a range of pressure values is used, comprising a low value and a high value, the valve can direct the cleaning fluid to the first outlet for inlet pressures below the low value, and to the second outlet for inlet pressures above the high value. No outlet is thus selected when the inlet pressure to the directional valve 130 is between the low value and the high value.

In the text hereinbelow, an ad hoc threshold value is used for illustrative purposes. No restrictions are placed on the threshold value, which may notably be fixed, or even mechanically adjusted, as a function of the respective optimum operating values of the first spray nozzle 140.1 and the second spray nozzle 140.2.

According to preferential embodiments, the first spray nozzle 140.1 has at least a first optimum operating value, and the second spray nozzle 140.2 has at least a second optimum operating value, different from the first optimum operating value. The optimum operating values may be respective flow rate values for the first spray nozzle 140.1 and the second spray nozzle 140.2. Alternatively, or additionally, the optimum operating values may be pressure values at the inlet of the spray nozzles 140.1 and 140.2. In particular, depending on the respective types of spray nozzle 140.1 and 140.2, the optimum nozzle inlet pressure and flow rate values may be varied. For example, each type of spray nozzle may define a relationship between spray nozzle flow rate value and inlet pressure.

The first and second spray nozzles 140.1 and 104.2 may advantageously be of two different types. They thus necessarily correspond to different optimum operating values, and it is thus possible to inject cleaning fluid selectively into one or the other by setting the given threshold to a value between valve 130 inlet pressure values associated with, or corresponding to, the optimum operating values of the two pumps.

Specifically, to obtain a given flow rate value in a spray nozzle with a given inlet pressure in the spray nozzle, a given pressure value is required at the inlet to the directional valve 130.

This given pressure value at the inlet to the directional valve 130 itself corresponds to a given speed of rotation of the pump motor 120.

Thus, a first optimum valve 130 inlet pressure value may be defined for the first spray nozzle 140.1 and a second optimum valve 130 inlet pressure value may be defined for the second spray nozzle 140.2. The threshold value is advantageously between the first optimum value and the second optimum value of the valve 130 inlet pressure.

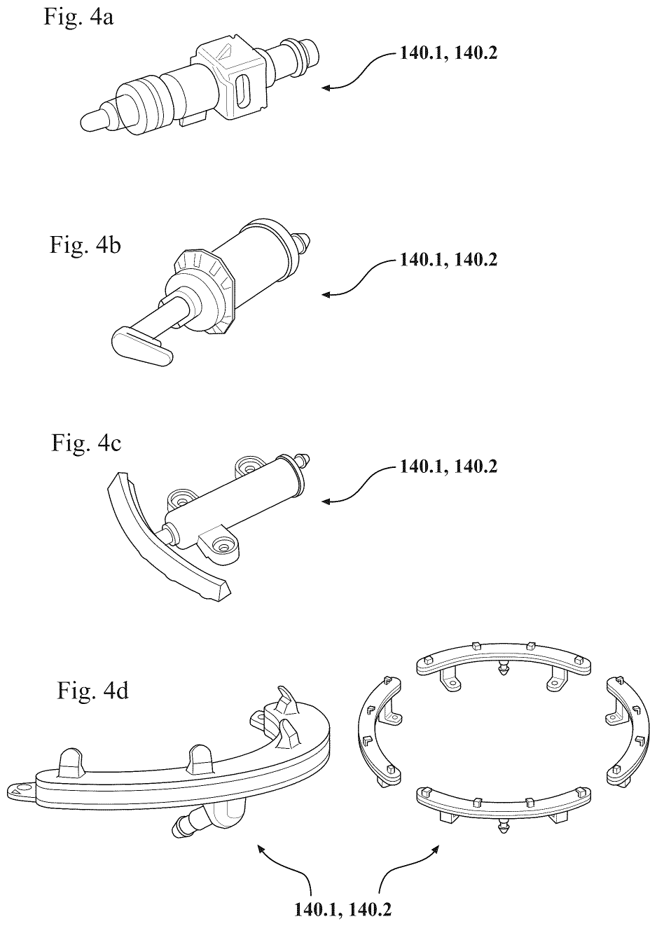

No restrictions are placed on the different types of spray nozzles that the first and second spray nozzles 140.1 and 140.2 may have. For example, the following examples are given as illustrations of possibilities:
a fixed single spray nozzle, represented in FIG. 4a, spraying cleaning fluid through a single aperture;
a fixed double spray nozzle, spraying cleaning fluid through two or more apertures;
a single telescopic spray nozzle, represented in FIG. 4b, spraying cleaning fluid through a single aperture;
a telescopic spraying boom with a plurality of spray nozzles, represented in FIG. 4c, each comprising an aperture for spraying cleaning fluid; and
a fixed spraying boom, represented in FIG. 4d, for example circular or semicircular, comprising several nozzles. Such a nozzle may be rotatable.

Such spray nozzles are well known and are not further described in the present description.

According to a first embodiment, the first spray nozzle 140.1 may be a single telescopic spray nozzle and the second spray nozzle 140.2 may be a fixed circular or semicircular spraying boom.

In this first embodiment, the optimum operating values may correspond to the values listed hereinbelow, given as a guide for actual spray nozzles:
first spray nozzle 140.1: optimum flow rate of 10.9 ml/s and optimum nozzle inlet pressure of 2.4 bar. These optimum values correspond to an optimum valve 130 inlet pressure value of 2.7 bar and a pump 120 rotation speed of 2000 rpm;
second spray nozzle 140.2: optimum flow rate of 32 ml/s and optimum nozzle inlet pressure of 2.2 bar. These optimum values correspond to an optimum valve 130 inlet pressure value of 3.3 bar and a pump 120 rotation speed of 4000 rpm.

Thus, by setting the given threshold of the directional valve strictly between 2.7 bar and 3.3 bar, which are the optimum inlet pressure values for valve 130, it is possible to select one or other of the spray nozzles 140.1 and 140.2, while at the same time injecting them with cleaning fluid according to their optimum operating values. The given threshold may, for example, be set at a value of 3 bar.

When the directional valve 130 receives cleaning fluid at a pressure of 2.7 bar, the inlet of the directional valve 130 is connected to the first outlet, and the directional valve thus feeds the first spray nozzle 140.1, which moreover is under optimum flow rate and pressure conditions.

When the directional valve 130 receives cleaning fluid at a pressure of 3.3 bar, the inlet of the directional valve 130 is connected to the second outlet, and the directional valve thus feeds the second spray nozzle 140.2, which moreover is under optimum flow rate and pressure conditions.

Thus, pump 120 can selectively inject cleaning fluid toward one or the other of the spray nozzles 140.1 and 140.2, under optimum conditions, without requiring active control of directional valve 130, simply by adapting the rotation speed of the pump motor.

According to a second embodiment, the first spray nozzle 140.1 may be a single telescopic spray nozzle and the second spray nozzle 140.2 may be a telescopic boom with several semicircular nozzles.

In this second embodiment, the optimum operating values may correspond to the values listed hereinbelow, given as a guide for actual spray nozzles:
first spray nozzle 140.1: as in the first embodiment, optimum flow rate of 10.9 ml/s and optimum nozzle inlet pressure of 2.4 bar. These optimum values correspond to an optimum valve 130 inlet pressure value of 2.7 bar and a pump 120 rotation speed of 2000 rpm;
second spray nozzle 140.2: optimum flow rate of 37.5 ml/s and optimum nozzle inlet pressure of 2.5 bar. These optimum values correspond to an optimum valve 130 inlet pressure value of 3.9 bar and a pump 120 rotation speed of 5000 rpm.

Thus, as in the first embodiment, by setting the given threshold of the directional valve strictly between 2.7 bar and 3.9 bar, which are the optimum inlet pressure values for valve 130, it is possible to select one or other of the spray nozzles 140.1 and 140.2, while at the same time injecting them with cleaning fluid according to their optimum operating values. The given threshold may, for example, be set at a value of 3.3 bar.

When the directional valve 130 receives cleaning fluid at a pressure of 2.7 bar, the inlet of the directional valve 130 is connected to the first outlet, and the directional valve thus feeds the first spray nozzle 140.1, which moreover is under optimum flow rate and pressure conditions.

When the directional valve 130 receives cleaning fluid at a pressure of 3.9 bar, the inlet of the directional valve 130 is connected to the second outlet, and the directional valve thus feeds the second spray nozzle 140.2, which moreover is under optimum flow rate and pressure conditions.

Thus, pump 120 can selectively inject cleaning fluid toward one or the other of the spray nozzles 140.1 and 140.2, under optimum conditions, without requiring active control of directional valve 130.

FIG. 2 illustrates the structure of a directional valve 130 according to certain embodiments of the invention.

The directional valve 130 comprises an inlet 131, a first outlet 132.1 that can be connected to the first distribution channel 160.1 described previously, and a second outlet that can be connected to the second distribution channel 160.2 described previously.

Depending on the cleaning fluid pressure in inlet 131, the directional valve 130 is capable of connecting the inlet to the first outlet 132.1 or to the second outlet 132.2. To this end, the directional valve 130 may comprise a piston 134 and a spring 135, the cleaning fluid applying a pressure to the piston 134 which is transmitted to the spring 135, and which leads the piston 134 to obtain an equilibrium position which is a function of the pressure exerted by the cleaning fluid at the inlet, and of the constant of the spring 135 and of its position.

The directional valve may comprise a distribution element 133, which moves integrally with the piston, and which may be positioned opposite a first interface of the first outlet 132.1 or opposite a second interface of the second outlet 132.2, depending on the equilibrium position of the piston 134.

The pressure threshold value thus corresponds to a pressure value at which the distribution element 133 is located between the first interface and the second interface. For pressures below the given threshold, the distribution element thus faces the first interface, while for pressures above the given threshold, the distribution element 133 faces the second interface.

The directional valve 130 may also comprise an adjusting element 136 that is capable of varying the position of the spring 135, so as to vary the given threshold of the directional valve. The adjusting element can slide in the same channel as the piston 134 while at the same time having a fixed position, which cannot be moved by the spring 135. In this manner, when the adjusting element 136 is moved to the right, and thus toward the piston 134, the spring 135 is compressed and the given threshold is increased. Conversely, when the adjusting element 136 is moved to the left, and thus away from the piston 134, the spring 135 is relaxed and the given threshold is reduced.

The adjusting element 136 may be a screw, which facilitates adjustment of the given threshold. Specifically, the screw head is rotated in one direction or the other to cause it to move and induce a change in the pressure threshold.

FIG. 3 represents another embodiment of a directional valve. In this embodiment, the directional valve comprises a first connecting channel 21.1 through which the fluid can flow, connected to the inlet 131 and the first outlet 132.1 and a first valve head 23.1 provided with a first loading means 25.1, which is movable inside the first connecting channel 21.1 between an open position when the fluid has a pressure below the given threshold and a closed position when the fluid has a pressure above the given threshold.

The first connecting channel 21.1 is configured to be closed when the first valve head 23.1 moves from its open position to its closed position. Here, the first connecting channel 21.1 comprises a first constriction 27.1 downstream of the first valve head 23.1, and the first valve head 23.1 is a ball having a diameter larger than the largest dimension of the first constriction 27.1, so that in the closed position, the ball plugs the first connecting channel 21.1 at the first constriction 27.1.

In this embodiment, the directional valve also comprises a second connecting channel 21.2 through which fluid can flow, connected to the inlet 131 and to the second outlet 132.2, and a second valve head 23.2 provided with a second loading means 25.2, which is movable inside the second connecting channel 21.2 between an open position when the fluid has a pressure above the given threshold and a closed position when the fluid has a pressure below the given threshold. The second connecting channel 21.2 is configured to be closed when the second valve head 23.2 moves from its open position to its closed position. Here, the second connecting channel 21.2 comprises a second constriction 27.2 upstream of the second valve head 23.2, and the second valve head 23.2 is a ball having a diameter larger than the largest dimension of the second constriction 27.2, so that in the closed position, the ball plugs the second connecting channel 21.2 at the second constriction 27.2.

Here, the first and second loading elements are return elements, for example springs.

In FIG. 3, the first valve head 23.1 is in an open position and the second valve head 23.2 is in a closed position. The inlet pressure is thus below the given threshold, and the fluid exits through the first outlet 132.1.

When the fluid pressure is greater than the given threshold, the first valve head 23.1 is in a closed position and the second valve head 23.2 is in an open position, and the fluid exits through the second outlet 132.2.

There is also an embodiment in which the first valve head 23.1 is configured to move from the open to the closed position when the fluid pressure is above a first threshold, and the second valve head 23.2 is configured to move from the closed to the open position when the fluid pressure is above a second threshold. Thus, if the first threshold is greater than the second threshold, when the fluid pressure is between the first and second thresholds, the first and second valve heads 23.1, 23.2 are in the open position and the fluid can exit through the first and second outlets 131.1, 131.2. If the first threshold is lower than the second threshold, when the fluid pressure is between the first and second thresholds, the first and second valve heads 23.1, 23.2 are in the closed position and the fluid cannot flow out of either of the first and second outlets 132.1, 132.2.

The invention is not limited to the examples just described, and numerous adjustments may be made to these examples without departing from the context of the invention.

What is claimed is:

1. A cleaning fluid spraying system comprising:
a first spray nozzle and a second spray nozzle, each capable of receiving cleaning fluid and of spraying the cleaning fluid out of the spraying system,
a directional valve including an inlet, a first outlet and a second outlet, the directional valve being capable of directing cleaning fluid from the inlet to the first outlet when cleaning fluid received at the inlet has a pressure below a given threshold, and capable of directing cleaning fluid from the inlet to the second outlet when cleaning fluid received at the inlet has a pressure above the given threshold.

2. The spraying system as claimed in claim 1, wherein the first spray nozzle has at least one first optimum operating value and the second spray nozzle has at least one second optimum operating value, the second optimum operating value being different from the first optimum operating value, with the first optimum operating value of the first spray nozzle being associated with a first cleaning fluid inlet pressure below the given threshold, and with the second optimum operating value of the second spray nozzle being associated with a second cleaning fluid inlet pressure above the given threshold.

3. The spraying system as claimed in claim 2, wherein at least one first optimum operating value is a flow rate value of the first spray nozzle and/or an inlet pressure value of the first spray nozzle, and the at least one second optimum operating value is a flow rate value of the second spray nozzle and/or a pressure value of the second spray nozzle.

4. The spraying system as claimed in claim 1, wherein the first spray nozzle is of a first type, the first type defining a first relationship between spray nozzle flow rate value and spray nozzle inlet pressure value, and the second spray nozzle is of a second type, the second type defining a second relationship between spray nozzle flow rate value and spray nozzle inlet pressure value.

5. The spraying system as claimed in claim 1, wherein the first spray nozzle is of a first type and the second spray nozzle is of a second type, the first and second types are from among:
a fixed single spray nozzle;
a fixed double spray nozzle;
a single telescopic spray nozzle;
a telescopic spraying boom comprising several spray nozzles; and
a fixed spraying boom in the form of a circular arc, for example circular or semicircular, comprising several spray nozzles.

6. The spraying system as claimed in claim 1, wherein the first spray nozzle is a single telescopic spray nozzle and the second spray nozzle is a fixed spraying boom in the form of a circular arc with several spray nozzles.

7. The spraying system as claimed in claim 1, wherein the first spray nozzle is a single telescopic spray nozzle and the second spray nozzle is a telescopic boom with several nozzles.

8. The spraying system as claimed in claim 1, wherein the directional valve includes a piston in contact with a spring, the piston being capable of sliding in the directional valve to adopt an equilibrium position as a function of a position of the spring and of the pressure of the cleaning fluid entering the directional valve, with the position of the spring being adjustable by means of an adjusting element in such a manner as to modify the given threshold.

9. The spraying system as claimed in claim 8, wherein the adjusting element is a screw, the screw being capable of moving the position of the spring when a rotation is applied to the screw so as to modify the given threshold.

10. The spraying system as claimed in claim 1, wherein the directional valve includes:
a first connecting channel through which the fluid can flow, connected to the inlet and to the first outlet,
a first valve head provided with a first loading means, which is movable inside the first connecting channel between an open position when the fluid has a pressure below the given threshold and a closed position when the fluid has a pressure above the given threshold,
a second connecting channel through which fluid can flow, connected to the inlet and to the second outlet,
a second valve head provided with a second loading means, which is movable inside the second connecting channel between an open position when the fluid has a pressure above the given threshold and a closed position when the fluid has a pressure below the given threshold, and
the first connecting channel being configured to be closed when the first valve head moves from the first valve head open position to the first valve head closed position, the second connecting channel being configured to be closed when the second valve head moves from the second valve head open position to the second valve head closed position.

11. An assembly comprising a spraying system, the spraying system including a first spray nozzle and a second spray nozzle, each capable of receiving cleaning fluid and of spraying the cleaning fluid out of the spraying system, a directional valve including an inlet, a first outlet and a second outlet, the directional valve being capable of directing cleaning fluid from the inlet to the first outlet when cleaning fluid received at the inlet has a pressure below a given threshold, and capable of directing cleaning fluid from the inlet to the second outlet when cleaning fluid received at the inlet has a pressure above the given threshold, and at least a first protective surface of a sensor and a second protective surface of a sensor, the first nozzle being configured to spray fluid onto the first protective surface and the second nozzle being configured to spray fluid onto the second protective surface.

12. The assembly as claimed in claim 11, further comprising a first sensor configured to emit and/or receive signals through the first protective surface, and a second sensor configured to emit and/or receive signals through the second protective surface.
